(19) United States
(12) Patent Application Publication
(10) Pub. No.: US 2004/0230876 A1
(43) Pub. Date: Nov. 18, 2004

(54) Information terminal device and method of processing electronic information of information terminal device

(75) Inventor: Hiroshi Moribe, Shinagawa-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/844,512

(22) Filed: May 13, 2004

(30) Foreign Application Priority Data
May 14, 2003 (JP) 2003-136039

(51) Int. Cl. H02H 3/05

(52) U.S. Cl. 714/45

(57) ABSTRACT

An information terminal device is able to send information such as a message or the like to a plurality of users of the single information terminal device while reducing tedious and time-consuming operations, without the need for operating an input unit that is connected to the information terminal device. Information determinator extracts electronic information which satisfies a desired condition or conditions set in information determination setting unit, from electronic information received by information acquisition unit, and outputs the extracted electronic information to information manipulator. Information manipulator manipulates the electronic information extracted by information determinator, and outputs a shared image display signal for displaying a shared image that displays information represented by the manipulated electronic information and that can be viewed by users who log in to information terminal device, to manipulated information display, thus causing manipulated information display to display the shared image.

### BACKGROUND OF THE INVENTION

1. Field of the Invention

The present invention relates to an information terminal device and a method of processing electronic information of such an information terminal device, and more particularly to an information terminal device which is capable of promoting communications in a group such as a family or the like and a method of processing electronic information of such an information terminal device.

2. Description of the Related Art

There has conventionally been a system for promoting communications in a family using a plurality of information terminal devices such as personal computers or the like.

FIG. 1 of the accompanying drawings is a block diagram of a system for promoting communications in a family using a plurality of personal computers.

As shown in FIG. 1, the system for promoting communications in a family includes dedicated server 31 and a plurality of personal computers 32 for use by respective members of the family. Dedicated server 31 manages personal computers 32. Dedicated server 31 is connected to Internet 33, and transmits information received from information terminal equipment 34 via Internet 33 to personal computers 32.

In order to realize the system shown in FIG. 1, it is necessary to construct a home network. Considerable professional knowledge is needed to construct and maintain the home network, and it is troublesome to manage the home network. Further, the system shown in FIG. 1 needs dedicated server 31 and personal computers for personal use. Therefore, there has been a problem that a large expenditure is required to realize the system shown in FIG. 1, and the system itself consists of a substantial setup.

There have been commercially available personal computers that are capable of promoting communications in a group such as a family or the like and solving the problem that family members have to own their personal computers, respectively.

Though a personal computer of this type is a single personal computer, it can be used as if there are as many different personal computers as the number of family individuals. Specifically, the personal computer can accept log-ins from a plurality of preset users, and perform personal authentication based on passwords or the like that are entered by the users when logged in, thereby protecting privacy of each user. For example, when the personal computer is used, the users exchange e-mail messages independently of each other, and even family members are unable to access e-mail messages of other family members.

The personal computer has an electronic message board that can be viewed by any users who have logged in, as a tool for promoting communications between a plurality of preset users. The electronic message board can have only messages registered therein which have been entered by operating an input unit such as a keyboard or the like that is connected to the personal computer.

With the above personal computer, messages must be registered in the electronic message board, which can be viewed by any users who have logged in, through the input unit that is connected to the personal computer.

Consequently, if someone wants to send information such as a message or the like to a plurality of users of the personal computer from a location where the input unit connected to the personal computer cannot directly be operated, then that person needs to perform a tedious and time-consuming task of sending the same e-mail message individually to those users of the personal computer.

It is possible to set up family-shared mail to meet the need of such information transmission, i.e., sending information such as a message or the like to a plurality of users of the personal computer from a location where the input unit connected to the personal computer cannot directly be operated. However, since family-shared mail has to be managed and operated, extra cost and management is required, a tedious and time-consuming process of checking family-shared mail messages has to be performed. Furthermore, there is always a possibility of forgetting to check family-shared mail messages.

### SUMMARY OF THE INVENTION

It is an object of the present invention to provide an information terminal device which makes it possible to send information such as a message or the like to a plurality of users of the single information terminal device without the need for operating an input unit that is connected to the information terminal device, and a method of processing electronic information of the information terminal device.

To achieve the above object, in an information terminal device and a method of processing electronic information of the information terminal device according to the present invention, a shared image display signal is output for displaying a shared image that displays information represented by electronic information which satisfies a desired condition or conditions set in a condition setting unit, of electronic information addressed to each of a plurality of users of the information terminal device via a communication network and that can be viewed by users who log in to the information terminal device.

According to the present invention, when electronic information which satisfies a desired condition or conditions is transmitted to either one of the users of the information terminal device, information represented by the transmitted information is displayed in a shared image that can be viewed by the users of the information terminal device. Therefore, it is possible to send information such as a message or the like to the users of the information terminal device, without the need for a tedious and time-consuming task of transmitting e-mail messages of the same content to the users of the information terminal device or managing shared mail, and also without directly operating an input unit of the information terminal device.

According to the present invention, therefore, smooth communications may be performed within a group made up of a plurality of users of the information terminal device.

Since communications within a certain group made up of a plurality of persons can be made smooth simply by using the single information terminal device, expenses may be lower than the expenses of a system in which those persons use respective dedicated information terminal devices and a system arrangement for smoothing communications within the group may be smaller in size than arrangement of a system in which those persons use respective dedicated information terminal devices.

By appropriately setting a desired condition, it is possible to automatically provide a plurality of users of the information terminal device with electronic information that is thought to be required by those users of the information terminal device, among the electronic information that is sent to either one of the users of the information terminal device.

In the information terminal device and the method of processing electronic information of the information terminal device according to the present invention, electronic information including a title and contents is received, and the condition setting unit sets a condition as to the title of the electronic information and/or a condition as to the contents of the electronic information, as the desired condition.

The invention as described above offers the same advantages as those described above. In addition, when information such as a message or the like is to be sent from a location where the input unit of the information terminal device cannot directly be operated, it is possible to send the information to the users of the information terminal device by incorporating the desired condition in the title or contents of the electronic information.

Therefore, the sender of electronic information can select whether or not the electronic information is to be transmitted to a plurality of users of the information terminal device.

In the information terminal device and the method of processing electronic information of the information terminal device according to the present invention, if the condition setting unit sets a plurality of desired conditions, a shared image display signal is output for displaying a shared image that displays information represented by the electronic information which satisfies either one of the desired conditions. In addition to the above advantages, by setting a plurality of desired conditions that are different from each other, the number of types of electronic information that can be sent to a plurality of users of the information terminal device can be increased.

In the information terminal device and the method of processing electronic information of the information terminal device according to the present invention, electronic information which satisfies the desired condition set in the condition setting unit, of the electronic information which is received, is manipulated, and a shared image display signal is output for displaying a shared image which displays at least information represented by the manipulated electronic information. In addition to the above advantages, it is possible to manipulate information displayed in the shared image into a format that can easily be viewed.

In the information terminal device and the method of processing electronic information of the information terminal device according to the present invention, if the electronic information which satisfies the desired condition has image data, a first manipulation is effected on the electronic information, and if the electronic information which satisfies the desired condition is electronic information exclusive of image data, a second manipulation, which is different from the first manipulation, is effected on the electronic information.

According to the invention as described above, in addition to the above advantages, electronic information can be manipulated differently depending on whether it has image data or not, and hence can be manipulated depending on the contents thereof.

In the information terminal device and the method of processing electronic information of the information terminal device according to the present invention, only electronic information which satisfies either one of desired conditions set in the condition setting unit, of the electronic information that is received, is output, and the output electronic information is manipulated according to the desired condition which is satisfied by the electronic information.

According to the invention as described above, in addition to the above advantages, the display format of the electronic information displayed in the shared image can be changed for each desired condition used to extract the electronic information, and the information displayed in the shared image can be classified according to display format.

In the information terminal device and the method of processing electronic information of the information terminal device according to the present invention, it is preferable to display a shared image based on a shared image display signal.

In the information terminal device and the method of processing electronic information of the information terminal device according to the present invention, each of the users who log in to the information terminal device is prohibited from displaying electronic information addressed to other users on a display. Therefore, the privacy of each of the users can be protected and information such as a message or the like can be sent to a plurality of users of the information terminal device.

The above and other objects, features, and advantages of the present invention will become apparent from the following description with reference to the accompanying drawings that illustrate an example of the present invention.

### BRIEF DESCRIPTION OF THE DRAWINGS

FIG. 1 is a block diagram of a conventional system for promoting communications in a family;

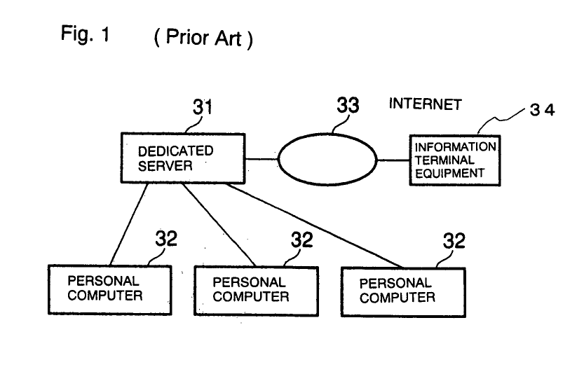

FIG. 2 is a block diagram of an information terminal device according to an embodiment of the present invention; and

FIG. 3 is a flowchart of an operation sequence of the information terminal device shown in FIG. 2.

### DETAILED DESCRIPTION OF THE PREFERRED EMBODIMENT

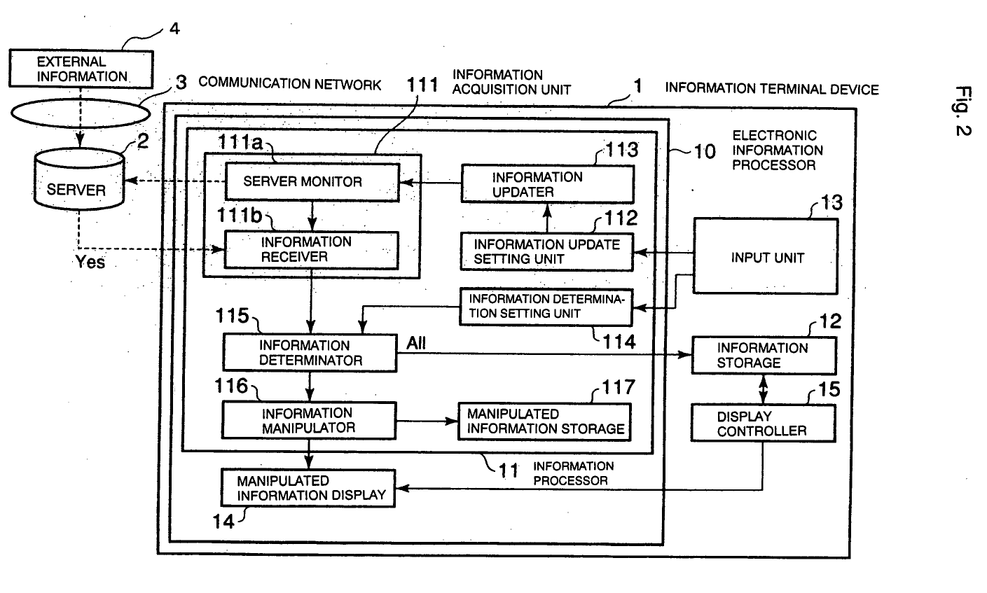

FIG. 2 shows in block form an information terminal device according to an embodiment of the present invention.

As shown in FIG. 2, information terminal device 1 includes electronic information processor 10, information storage 12, input unit 13 such as a keyboard or the like, and display controller 15. Electronic information processor 10 includes information processor 11 and manipulated information display 14. Information processor 11 includes information acquisition unit 111, information update setting unit 112, information updater 113, information determination setting unit 114, information determinator 115, information manipulator 116, and manipulated information storage 117. Information acquisition unit 111 includes server monitor 111a and information receiver 111b.

Information terminal device 1, which may be a personal computer or the like, can accept log-ins from a plurality of preset users. A plurality of preset users will hereinafter be referred to as a plurality of users.

The term “log-in” covers the term “log-on”, and means access to information terminal device 1 (specifically, resources such as software that information terminal device 1 has) and also accessibility to information terminal device 1 (specifically, resources such as software that information terminal device 1 has).

Server 2, which may be a mail/contents server or the like, receives external information 4 as electronic information via communication network 3 such as the Internet or the like. Specifically, server 2 receives electronic information addressed to each of the users of at least information terminal device 1.

Information terminal device 1 receives, with electronic information processor 10, electronic information addressed to users who log in to information terminal device 1, via communication network 3 and server 2, and saves the received electronic information in information storage 12.

Information terminal device 1 performs personal authentication on users who log in to information terminal device 1 using authentication information such as passwords or the like, and allows each of the users who have logged in to view only the electronic information addressed to himself or herself, of all the electronic information stored in information storage 12.

Information update setting unit 112 sets up an interval at which server monitor 111a accesses server 2, based on an input from input unit 13.

Information updater 113 outputs an updating timing signal to server monitor 111a of information acquisition unit 111, at the interval set up by information update setting unit 112.

Information acquisition unit 111, which serves as a receiver, receives electronic information addressed to each of the users of information terminal device 1 via communication network 3. Specifically, information acquisition unit 111 accesses server 2 and receives electronic information unreceived by information acquisition unit 111 among the electronic information that is addressed to each of the users of information terminal device 1.

More specifically, server monitor 111a of information acquisition unit 111 accesses server 2 each time that an updating timing signal output from information updater 113 is input to server motor 111a, and monitors whether or not there is electronic information unreceived by information receiver 111b among the electronic information that is addressed to each of the users of information terminal device 1. If there is electronic information unreceived by information receiver 111b among the electronic information that is addressed to each of the users of information terminal device 1, then server monitor 111a outputs a notification signal indicative of the reception of the unreceived electronic information from server 2 to information receiver 111b.

When the notification signal output from server monitor 111a is input to information receiver 111b of information acquisition unit 111, information receiver 111b accesses server 2 and receives, from server 2, the unreceived electronic information of the electronic information that is addressed to each of the users of information terminal device 1.

Information determination setting unit 114, which serves as a condition setting unit, sets up one or more desired conditions for selecting electronic information received by information acquisition unit 111 based on an input from input unit 13.

Information determinator 115 saves all the electronic information received by information acquisition unit 111 in information storage 12.

Information determinator 115 extracts only electronic information which satisfies a desired condition set in information determination setting unit 114, from the electronic information received by information acquisition unit 111, and outputs the extracted electronic information to information manipulator 116. If a plurality of desired conditions are set in information determination setting unit 114, then information determinator 115 outputs only electronic information which satisfies either one of the desired conditions to information manipulator 116.

Information manipulator 116, which serves as a shared image controller, outputs, to manipulated information display 14, a shared image display signal for displaying a shared image that displays information represented by electronic information output from at least information determinator 115 and that can be viewed by users who have logged in.

Specifically, information manipulator 116 manipulates electronic information output from information determinator 115, and outputs a shared image display signal for displaying a shared image that displays at least information represented by the manipulated electronic information, to manipulated information display 14. Information manipulator 116 also saves the manipulated electronic information in manipulated information storage 117.

If electronic information input from information determinator 115 has image data, then information manipulator 116 effects a first manipulation on the electronic information having image data. If electronic information input from information determinator 115 is electronic information having no image data, then information manipulator 116 effects a second manipulation, which is different from the first manipulation, on the electronic information having no image data.

For example, in the first manipulation, information manipulator 116 manipulates the electronic information such that an area in which an image based on the image data is displayed is greater than an area in which an image prior to the manipulation is displayed. In the second manipulation, information manipulator 116 manipulates the electronic information, i.e., electronic information that has no image data, but has only character data, such that characters based on the character data are positioned at the center of a display area.

If a plurality of desired conditions are set in information determination setting unit 114, then information manipulator 116 manipulates electronic information input from information determinator 115 according to the desired conditions that are satisfied by the electronic information.

For example, if a first desired condition and a second desired condition are set in information determination setting unit 114, then information manipulator 116 manipulates electronic information which is extracted based on the first desired condition such that a display background for information represented by the extracted electronic information has a first color, and manipulates electronic information which is extracted based on the second desired condition such that a display background for information represented by the extracted electronic information has a second color which is different from the first color.

Information manipulator 16 also displays a message input from input unit 13 in the shared image. Therefore, the shared image is capable of displaying information represented by the electronic information that satisfies the desired condition or conditions and also a message input from input unit 13. However, the shared image may display only information represented by the electronic information that satisfies the desired condition or conditions.

Manipulated information display 14, which serves as a display, displays a shared image based on a shared image display signal output from information manipulator 116.

The shared image may be viewed by all users who have logged in to information terminal device 1.

If electronic information output from information determinator 115 specifies a desired number of users among a plurality of users, as users who can view the electronic information, then the shared image may be viewed by only those specified users. In this case, information manipulator 116 may output, to manipulated information display 14, a shared image display signal for displaying a shared image that can be viewed by only users who are specified by the electronic information output from information determinator 115.

Display controller 15 authenticates users who log in to information terminal device 1 using authentication information such as passwords or the like, thus prohibiting each of the users who log in to information terminal device 1 from displaying electronic information addressed to other users on manipulated information display 14.

Operation of information terminal device 1 will be described below.

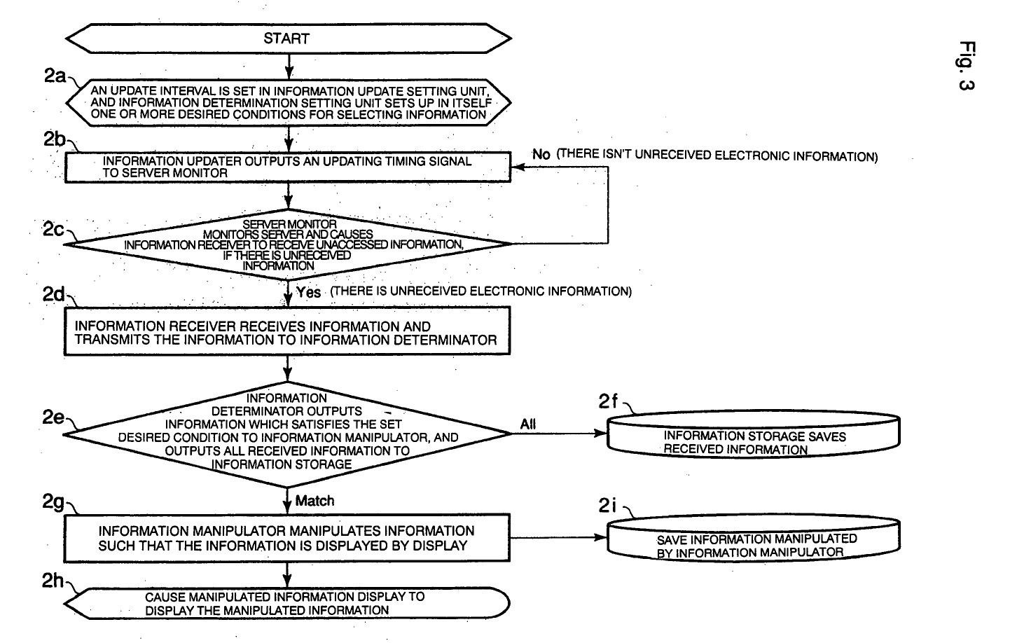

FIG. 3 is a flowchart of an operation sequence of information terminal device 1. Operation of information terminal device 1 will be described below with reference to FIG. 3.

In step 2a, when input unit 13 is operated to enter an interval at which server monitor 111a accesses server 2, the interval entered from input unit 13 is set in information update setting unit 112 as the interval at which server monitor 111a accesses server 2.

When input unit 13 is operated to enter desired condition or conditions for selecting electronic information received by information acquisition unit 111, information determination setting unit 114 sets up, in itself (information determination setting unit 114), one or more desired conditions for selecting electronic information received by information acquisition unit 111 based on the input from input unit 13.

In step 2b, information updater 113 outputs an updating timing signal to server monitor 111a at the interval set up by information update setting unit 112.

In step 2c, when the updating timing signal is input to server monitor 111a, server monitor 111a accesses server 2 and monitors whether or not there is electronic information unreceived by information receiver 111b among the electronic information that is addressed to each of the users of information terminal device 1. If there is electronic information unreceived by information receiver 111b of the electronic information that is addressed to each of the users of information terminal device 1, then server monitor 111a outputs, to information receiver 111b, a notification signal indicative of the reception of the unreceived electronic information from server 2.

In step 2d, when the notification signal output from server monitor 111a is input to information receiver 111b, information receiver 111b accesses server 2 and receives, from server 2, the unreceived electronic information of the electronic information that is addressed to each of the users of information terminal device 1, and transmits the received electronic information to information determinator 115.

In step 2e, information determinator 115 extracts electronic information which satisfies the desired condition or conditions set in information determination setting unit 114, from the electronic information received by information acquisition unit 111, and outputs the extracted electronic information to information manipulator 116. Information determinator 115 outputs all the electronic information received by information acquisition unit 111 to information storage 12.

In step 2f, information storage 12 saves the information output from information determinator 115, i.e., saves all the electronic information received by information acquisition unit 111.

In step 2g, information manipulator 116 manipulates the electronic information extracted by information determinator 115.

In step 2h, information manipulator 116 outputs a shared image display signal for displaying a shared image that displays information represented by the manipulated electronic information and that can be viewed by users who have logged in to information terminal device 1, to manipulated information display 14, causing manipulated information display 14 to display the shared image.

In step 2i, information manipulator 116 saves the manipulated information in manipulated information storage 117.

The users who can view the shared image may be all the users of the information terminal device 1 or a desired number of users among the users of the information terminal device 1.

According to the present embodiment, when electronic information which satisfies a desired condition or conditions is transmitted to either one of users of information terminal device 1, information represented by the transmitted information is displayed in a shared image that can be viewed by the users of information terminal device 1. Therefore, it is possible to send information such as a message or the like from a location where input unit 13 of information terminal device 1 cannot directly be operated to a plurality of users of information terminal device 1, without the need for a tedious and time-consuming task of transmitting e-mail messages of the same content to the users of information terminal device 1 or managing shared mail.

Since communications within a certain group made up of a plurality of persons can be made smooth simply by using single information terminal device 1, expenses may be lower and a system arrangement for smoothing communications within the group may be smaller in size than a case that those persons use respective dedicated information terminal devices.

In particular, in case information terminal device 1 has display controller 15 for prohibiting each of the users who log in to information terminal device 1 from displaying electronic information addressed to other users on manipulated information display 14, the privacy of electronic information addressed to the users can be protected and communications between the users can be promoted.

If information acquisition unit 111 receives electronic information including a title and contents, and a condition as to the title of electronic information and/or a condition as to the contents of the electronic information is set up as a desired condition in information determination setting unit 114, then when information such as a message or the like is to be sent from a remote location, e.g., a location where a user has gone to, to a plurality of users of information terminal device 1, it is possible to send the information to the users of information terminal device 1 by including the desired condition in the title or contents of the electronic information indicative of that information.

For example, if the word “family” is set in information determination setting unit 114 as a condition as to the title of electronic information which serves as desired condition, then when electronic information including the word “family” in its title is transmitted from an information terminal device at a remote location to either one of the users of information terminal device 1, information indicated by the electronic information including the word “family” in its title is displayed on manipulated information display 14 as displayed contents of a shared image that can be viewed by the users of information terminal device 1.

Therefore, the sender of electronic information can select whether or not the electronic information is to be transmitted to a plurality of users of information terminal device 1.

By appropriately setting a desired condition in information determination setting unit 114, it is possible to automatically provide a plurality of users of information terminal device 1 with electronic information which is thought to be required by those users of information terminal device 1, among the electronic information that is sent to either one of the users of information terminal device 1.

For example, if electronic information transmitted from a certain sender is to be shared by a plurality of users of information terminal device 1, then when the certain sender is set as a desired condition, the electronic information transmitted from the certain sender can be shared by the users of information terminal device 1. An example of the certain sender is an enterprise engaging in a campaign or a sale.

If electronic information which is thought to include certain information, among electronic information transmitted to either one of users of information terminal device 1, is to be shared by a plurality of users of information terminal device 1, then when a condition that a word indicative of particular information is included in a title and/or contents is set as a desired condition, it is possible to share the electronic information which is thought to include certain information between the users of information terminal device 1. A condition that a certain word is included a predetermined number of times or more may be used as a desired condition.

By setting a plurality of desired conditions that are different from each other in information determination setting unit 114, the number of types of electronic information that can be sent to a plurality of users of information terminal device 1 can be increased.

Since information manipulator 116 manipulates electronic information which satisfies a desired condition or conditions set in information determination setting unit 114 and outputs a shared image display signal for displaying a shared image that displays at least information represented by the manipulated electronic information, the information displayed in the shared image can be manipulated into a format that can easily be viewed.

According to an example of manipulation of electronic information by information manipulator 116, if electronic information extracted by information determinator 115 has image data, then information manipulator 116 effects a first manipulation on the electronic information having image data, and if electronic information extracted by information determinator 115 is electronic information exclusive of image data, then information manipulator 116 effects a second manipulation, which is different from the first manipulation, on the electronic information having no image data.

According to an example of the first and second manipulations performed by information manipulator 116, information manipulator 116 manipulates, in the first manipulation, the electronic information such that an area in which an image based on the image data is displayed is greater than an area in which an image prior to the manipulation is displayed, and information manipulator 116 manipulates, in the second manipulation, the electronic information, i.e., electronic information which has no image data, but has only character data, such that characters based on the character data are positioned at the center of a display area.

According to another example of manipulation of electronic information by information manipulator 116, if a plurality of desired conditions are set in information determination setting unit 114, then information manipulator 116 manipulates electronic information extracted by information determinator 115 according to the desired conditions that are satisfied by the electronic information.

For example, if a first desired condition and a second desired condition are set in information determination setting unit 114, then information manipulator 116 manipulates electronic information which is extracted based on the first desired condition such that a display background for information represented by the extracted electronic information has a first color (e.g., yellow), and manipulates electronic information which is extracted based on the second desired condition such that a display background for information represented by the extracted electronic information has a second color (e.g., yellowish green).

In this case, information displayed in the shared image can be classified according to display format.

A plurality of users of information terminal device 1 may be family members who use information terminal device 1. However, a plurality of users of information terminal device 1 are not limited to family members.

Furthermore, a plurality of users of information terminal device 1 are not limited to a plurality of physically separate users, but may be one user if the user acts as two users, e.g., by operating information terminal device 1 separately for business use and for private use.

Information processor 11 may comprise a memory as a computer-readable recording medium and a CPU as a computer. In this case, the memory serving as a component of information processor 11 stores a program run by the CPU to perform the above electronic information processing sequence, and the CPU serving as another component of information processor 11 reads the program stored in the memory and executes the above electronic information processing sequence according to the read program.

The program stored in the memory as a component of information processor 11 may be recorded in a computer-readable recording medium such as an optical disk or the like. In this case, when the program recorded in a computer-readable recording medium such as an optical disk or the like is read and then stored in the memory as a component of information processor 11, the CPU as another component of information processor 11 can execute the above electronic information processing sequence according to the read program.

While a preferred embodiment of the present invention has been described using specific terms, such description is for illustrative purposes only, and it is to be understood that changes and variations may be made without departing from the spirit or scope of the following claims.

What is claimed is:

1. An information terminal device to be logged in to by a plurality of users, comprising:
a condition setting unit for setting a desired condition therein;
a receiver for receiving electronic information addressed to the users via a communication network;
an information determinator for outputting only electronic information which satisfies the desired condition set in said condition setting unit, of the electronic information received by said receiver; and
a shared image controller for outputting a shared image display signal for displaying a shared image which displays at least information represented by the electronic information output by said information determinator and which can be viewed by users who log in to the information terminal device.

2. An information terminal device according to claim 1, wherein said receiver receives electronic information including a title and contents, and said condition setting unit sets a condition as to the title of said electronic information, as said desired condition.

3. An information terminal device according to claim 1, wherein said receiver receives electronic information including a title and contents, and said condition setting unit sets a condition as to the contents of said electronic information, as said desired condition.

4. An information terminal device according to claim 1, wherein said receiver receives electronic information including a title and contents, and said condition setting unit sets a condition as to the title of said electronic information and a condition as to the contents of said electronic information, as said desired condition.

5. An information terminal device according to claim 1, wherein said condition setting unit sets at least one desired condition, and if said condition setting unit sets a plurality of desired conditions, said information determinator outputs only electronic information which satisfies either one of the desired conditions, of the electronic information received by said receiver.

6. An information terminal device according to claim 1, wherein said shared image controller manipulates the electronic information output by said information determinator, and outputs a shared image display signal for displaying a shared image which displays at least information represented by the manipulated electronic information.

7. An information terminal device according to claim 6, wherein if the electronic information which satisfies the desired condition has image data, said shared image controller effects a first manipulation on said electronic information, and if the electronic information which satisfies the desired condition is electronic information exclusive of image data, said shared image controller effects a second manipulation, which is different from said first manipulation, on said electronic information, and wherein said shared image controller outputs a shared image display signal for displaying a shared image which displays at least information represented by the manipulated electronic information.

8. An information terminal device according to claim 6, wherein said condition setting unit sets a plurality of desired conditions, said information determinator outputs only electronic information which satisfies either one of the desired conditions set in said condition setting unit, of the electronic information received by said receiver, and said shared image controller manipulates the electronic information output by said information determinator according to the desired conditions which are satisfied by said electronic information, and outputs a shared image display signal for displaying a shared image which displays at least information represented by the manipulated electronic information.

9. An information terminal device according to claim 1, further comprising:
a display for displaying said shared image based on the shared image display signal output by said shared image controller.

10. An information terminal device according to claim 9, further comprising:
a display controller for prohibiting each of the users who log in to the information terminal device from displaying electronic information addressed to other users on said display.

11. A method of processing electronic information of an information terminal device for being logged in to by a plurality of users, comprising the steps of:
(a) setting a desired condition in a condition setting unit;
(b) receiving electronic information addressed to the users via a communication network;
(c) outputting only electronic information which satisfies the desired condition set in said step (a), of the electronic information received in said step (b); and
(d) outputting a shared image display signal for displaying a shared image which displays at least information represented by the electronic information output in said step (c) and which can be viewed by users who log in to the information terminal device.

12. A method according to claim 11, wherein said step (a) comprises the step of setting a condition as to a title of said electronic information, as said desired condition in said condition setting unit, and said step (b) comprises the step of receiving electronic information including a title and contents.

13. A method according to claim 11, wherein said step (a) comprises the step of setting a condition as to contents of said electronic information, as said desired condition in said condition setting unit, and said step (b) comprises the step of receiving electronic information including a title and contents.

14. A method according to claim 11, wherein said step (a) comprises the step of setting a condition as to a title of said electronic information and a condition as to contents of said electronic information, as said desired condition in said condition setting unit, and said step (b) comprises the step of receiving electronic information including a title and contents.

15. A method according to claim 11, wherein said step (a) comprises the step of setting at least one desired condition in said condition setting unit, and if a plurality of desired conditions are set in said condition setting unit in said step (b), said step (c) comprises the step of outputting only electronic information which satisfies either one of the desired conditions, of the electronic information received in said step (b).

16. A method according to claim 11, wherein said step (d) comprises the steps of manipulating the electronic information output in said step (c) and outputting a shared image display signal for displaying a shared image which displays at least information represented by the manipulated electronic information.

17. A method according to claim 16, wherein if the electronic information which satisfies the desired condition has image data, said step (d) comprises the step of effecting a first manipulation on said electronic information, and if the electronic information which satisfies the desired condition is electronic information exclusive of image data, said step (d) comprises the step of effecting a second manipulation, which is different from said first manipulation, on said electronic information, and wherein said step (d) comprises the step of outputting a shared image display signal for displaying a shared image which displays at least information represented by the manipulated electronic information.

18. A method according to claim 16, wherein said step (a) comprises the step of setting a plurality of desired conditions in said condition setting unit, said step (c) comprises the step of outputting only electronic information which satisfies either one of the desired conditions, of the electronic information received in said step (b), and said step (d) comprises the steps of manipulating the electronic information output in said step (c) according to the desired conditions which are satisfied by said electronic information, and outputting a shared image display signal for displaying a shared image which displays at least information represented by the manipulated electronic information.

19. A method according to claim 11, further comprising the step of:
(e) displaying said shared image on a display based on the shared image display signal output in said step (d).

20. A method according to claim 19, further comprising the step of:
(f) prohibiting each of the users who log in to the information terminal device from displaying electronic information addressed to other users on said display.

21. A program for enabling a computer to execute a method of processing electronic information of an information terminal device according to claim 11.
